(19) United States
(12) Patent Application Publication
(10) Pub. No.: US 2011/0156410 A1
(43) Pub. Date: Jun. 30, 2011

(54) LID STRUCTURE FOR VEHICLE

(75) Inventor: Mayumi OGAWA, Saitama (JP)

(73) Assignee: HONDA MOTOR CO., LTD., Tokyo (JP)

(21) Appl. No.: 12/977,498

(22) Filed: Dec. 23, 2010

(30) Foreign Application Priority Data
Dec. 28, 2009 (JP) 2009-296702

(51) Int. Cl. E05C 3/06

(52) U.S. Cl. 292/195

(57) ABSTRACT

A lid structure for a vehicle wherein a lid can be prevented from interfering with other component part unexpectedly. A holding hook is provided for immovably holding, in a half-opened state, a lid caused to rise up in an opening direction according to an operation of a pushbutton for unlocking the lid. The holding hook keeps the lid in the half-opened state by immovably holding a striker provided on the lid, and a full-opened state of the lid is permitted when the striker is operated by a rider.

### CROSS-REFERENCE TO RELATED APPLICATIONS

The present application claims priority under 35 USC 119 to Japanese Patent Application No. 2009-296702 filed on Dec. 28, 2009 the entire contents of which are hereby incorporated by reference.

### BACKGROUND OF THE INVENTION

1. Field of the Invention

The present invention relates to a lid structure for a vehicle, provided for the opening/closing of a storage part or the like in a vehicle.

2. Description of Background Art

Motorcycles include one in which a storage part is provided in the vicinity of a handle, and a lid capable of being opened and closed is additionally provided for the storage part. For instance, Japanese Patent No. 3871931 discloses a structure for a scooter type motorcycle wherein a hole is formed in that region of a leg shield covering a front portion of the vehicle which is in the vicinity of the handle, a storing container is inserted in the hole, and a lid is provided at an upper portion of the hole. In this vehicle, the storing container can be slid downward from a housing position where the storing container is wholly housed inside the leg shield, and the capacity of the storing container can be enlarged by the sliding. In addition, when the storing container has been further slid, the storing container as a whole can be dismounted on the lower side.

Meanwhile, in recent years, frequently attempt have been made to enhance the convenience in use for a rider by adopting a configuration in which the above-mentioned lid is made to be a type that is caused to rise up when, for example, a button is depressed, that is, a so-called pop-up type. A lid of such a pop-up type, however, is in principle accompanied by a problem wherein the lid, depending on the layout thereof, may interfere with other component parts unexpectedly. In a specific example, where the restoring part is provided in the vicinity of the handle as in Japanese Patent No. 3871931, an abrupt opening of the lid may result in interference of the lid with the handle operated for steering.

### SUMMARY AND OBJECTS OF THE INVENTION

The present invention has been made in consideration of the above-mentioned circumstances. Accordingly, it is an object of an embodiment the present invention to provide a lid structure for a vehicle in which a lid can be prevented from being unexpectedly opened to interfere with other component parts.

According to an embodiment the present invention, a lid structure for a vehicle is provided that includes a lid 26 provided additionally on a vehicle body (e.g., a motorcycle 1 in the embodiment) that is capable of being opened and closed with a lock means (e.g., a lock mechanism part 34 in the embodiment) for maintaining a closed state of the lid to establish a locked condition. The operating means (e.g., a pushbutton 27 in the embodiment) is provided for releasing the locking of the lock means to establish an unlocked condition, with the lid caused to rise up in an opening direction or with the lid permitted to rise up in the opening direction, according to an operation of the operating means for unlocking. The holding means (e.g., a holding hook 42, a latch 35, a case-side hook 51 in the embodiment) is provided for immovably holing in a half-opened state the lid put into the unlocked condition by the operating means, and a full-opened state of the lid is permitted when the holding of the holding means is released by a rider.

According to an embodiment the present invention, the lid is capable of being attached to and detached from the vehicle body.

According to an embodiment the present invention, the alarm indication means (e.g., a colored tape 43 in the embodiment) is provided which, when the operating means is in a position corresponding to the unlocked condition, indicates an alarm meaning that the unlocked condition is established.

According to an embodiment the present invention, the vehicle has a steering mechanism (e.g., a steering stem 4 in the embodiment) and a handle (e.g., a handlebar 7 in the embodiment) for operating the steering mechanism; and the lid is disposed on a vehicle body upper surface at such a position that at least part of the lid overlaps, in a top plan view, with a region on the inside of a locus of turning of an end portion of the handle during steering.

According to an embodiment the present invention, the vehicle has a storage box 25 and the lid is a lid of the storage box.

According to an embodiment the present invention, the holding means is composed of a latch 35 by which a striker 30 provided on the lid is immovably held in an engageable and disengageable manner.

According to an embodiment the present invention, a turnable cam member (e.g., a first cam member 36 in the embodiment) having the latch constituting the holding means is provided on the lower side of the operating means; the cam member can be transferred to a first state in which the operating means is not yet operated and a second state which is reached through turning from the first state when the operating means is operated to abut on the cam member; and it is ensured that in the first state, the striker is immovably held by the latch to establish the locked condition, that in the second state, the striker is moved while being immovably held by the latch to establish the half-opened state together with the unlocked condition, and that the full-opened state of the lid is permitted when the striker immovably held by the latch is disengaged by the rider after the second state.

According to an embodiment the present invention, the lock means is composed of a latch 35 by which a striker 30 provided on the lid is immovably held in an engageable and disengageable manner, and the holding means is composed of a hook member 42 which is provided on the vehicle body separately from the latch and by which the striker is immovably held in an engageable and disengageable manner.

According to an embodiment the present invention, a turnable cam member (e.g., a first cam member 36 in the embodiment) having the latch constituting the lock means is provided on the lower side of the operating means; the cam member can be transferred to a first state in which the operating means is not yet operated and a second state which is reached through turning from the first state when the operating means is operated to abut on the cam member; and it is ensured that in the first state, the striker is immovably held by the latch to establish the locked condition, that in the second state, the striker is released from the held-by-latch state to establish the unlocked condition, and that the full-opened state of the lid is permitted when, after the second state, the striker is immovably held by the hook member to establish a half-opened state and the striker immovably held by the hook member is disengaged by the rider.

According to an embodiment the present invention, a lever member 48 for releasing the immovable holding between the striker and the hook member is provided, and the immovable holding between the striker and the hook member is released when the lever member is operated in an opening direction for the lid.

According to an embodiment the present invention, the operating means is a pushbutton (e.g., a button body 40 in the embodiment) contained in an opening 39 provided in a vehicle body upper surface, the alarm indication means is provided at an inner edge portion (e.g., a front-side inner edge portion 39A in the embodiment) of the opening or at a side wall portion 39B extending downward along the inner edge portion (e.g., the front-side inner edge portion 39A in the embodiment) of the opening, and the alarm indication means appears only in the condition where the pushbutton is depressed.

According to an embodiment the present invention, with the operating means operated, the locked condition of the lid is released and the lid is caused to rise up in the opening direction or permitted to rise up but immovably held in a half-opened state by the holding means so that the lid cannot be fully opened unless the immovable holding by the holding means is released by the rider. Thus, a two-action structure can be configured. In addition, even if the lid is unlocked due to a wind pressure or vibrations or if the rider has forgotten to lock the lid, the lid would be prevented from opening unexpectedly; therefore, convenience in use can be enhanced. Further, it is possible to cause the rider to be conscious of a lid-opening motion. In addition, with the lid immovably held in the half-opened state, interference between the handle and the lid can be prevented from occurring. Therefore, the degree of freedom in layout of the lid can be enhanced; for example, the lid can be laid out in such a place that the lid and the handle overlap with each other in top plan view.

According to an embodiment the present invention, the lid is capable of being attached to and detached from the vehicle, which makes it possible to broaden an opening part and to enhance convenience in use. In addition, interference of the lid with other component part can be obviated once the lid is detached, so that the degree of freedom in layout can be enhanced.

According to an embodiment the present invention, it is possible by the alarm indication to cause the rider to recognize that the lid is not locked, so that it is possible to cause the rider to be conscious of a lid-opening motion.

According to an embodiment the present invention, the lid can be laid out in such a position so as to permit the rider to use it easily, so that convenience in use can be enhanced.

According to an embodiment the present invention, the use of the lid as a lid of a storage box ensures that the opening part is broadened, and stored articles can be easily taken out of the box and put into the box.

According to an embodiment the present invention, the structure under consideration can be configured by modifying only the part in the vicinity of the lid, so that the number of component parts modified from other specifications can be reduced.

According to an embodiment the present invention, the locked condition and the half-opened state of the lid can be realized through modification of the immovably held condition of the striker by the cam member alone, so that influences on other component parts are little and a reduction in cost can be achieved.

According to an embodiment the present invention, the locked condition and the half-opened state of the lid can be realized through modification of the immovably held condition of the striker provided on the lid, so that the number of component parts can be reduced.

According to an embodiment the present invention, the lid-opening operation can be carried out by use of the lever, without need to feel around for the striker, so that enhanced convenience in use can be given to the rider.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a motorcycle according to a first embodiment of the present invention;

FIG. 2 is a perspective view, from a right rear side, of the motorcycle;

FIG. 3 is an exploded perspective view for illustrating a lid structure according to the first embodiment;

FIG. 4 is a sectional view taken along line A-A of FIG. 2;

FIG. 5 is a sectional view for illustrating the lid in an unlocked condition and a half-opened state;

FIG. 6 illustrates a pushbutton for releasing the closed state of the lid;

FIG. 7 is a sectional view of a lid structure according to a second embodiment of the invention; and

FIG. 8 is a sectional view of a lid structure according to a third embodiment of the invention.

### DETAILED DESCRIPTION OF THE PREFERRED EMBODIMENTS

Embodiments of the present invention will be described below, based on the drawings. The sides or directions such as front (forward), rear (rearward), left (leftward), right (rightward), etc. in the following description are the same as those with reference to the vehicle, unless otherwise specified. In the drawings, arrow FR indicates the front side of the vehicle, arrow LH indicates the left side of the vehicle, and arrow UP indicates the upper side of the vehicle.

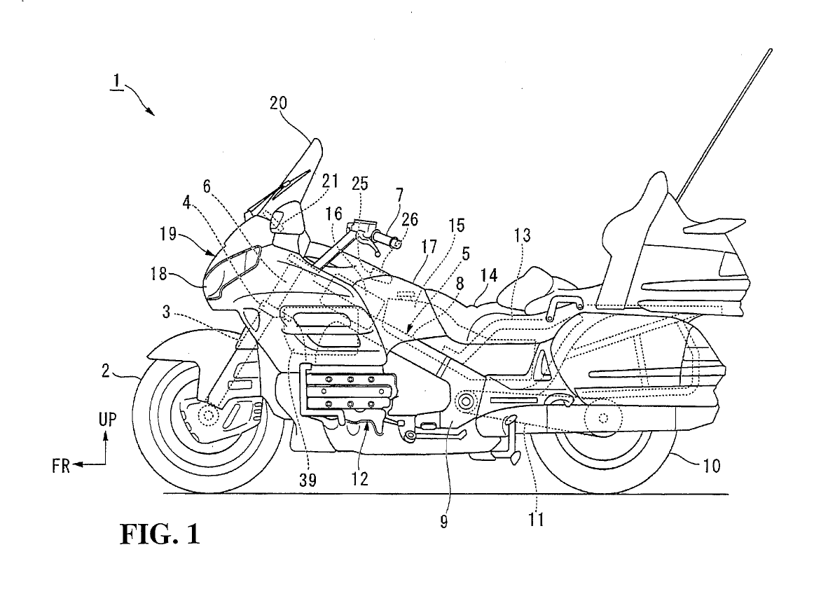

FIG. 1 shows a motorcycle 1 having a structure according to a first embodiment of the present invention. The motorcycle 1 includes a front wheel 2 that is rotatably supported on lower end portions of a pair of left and right front forks 3. Upper portions of the front forks 3 are steerably supported on a head pipe 6 at a front end portion of a body frame 5 through a steering stem 4. A handlebar 7 for steering the front wheel 2 is attached to an upper portion of the steering stem 4.

A pair of left and right main frames 8 constituting the body frame 5 extend downwardly and rearwardly from the head pipe 6. Upper end portions of a pair of left and right pivot plates 9 are connected to rear end portions of the left and right main frames 8. A front end portion of a swing arm 11 for rotatably supporting a rear wheel 10 at a rear end portion thereof is swingably supported on the pivot plates 9. A drive shaft (not shown) is inserted in the swing arm 11 wherein the transmission of power between the rear wheel 10 and an engine 12 is performed through the drive shaft. The engine 12 is, for example, a water-cooled, four-stroke, horizontally opposed six-cylinder type engine that is stationarily supported on the lower side of the main frames 8.

A pair of left and right seat rails 13 extending skewly and rearwardly are connected to the rear ends of the main frames 8 with a front seat 14 for the driver being provided on the upper side of the seat rails 13. On the front side of the front seat 14, a fuel tank 15 is disposed that extends to the lower side of the front seat 14. An air cleaner box 16 for filtration of engine intake air is disposed on the front side of the fuel tank 15.

A front portion of the vehicle body is covered with a front cowl 19 fitted with a pair of left and right headlamps 18. A windscreen 20 through which the front side of the vehicle is visible is provided on the upper side of a front portion of the front cowl 19. A meter panel 21 provided with a speedometer, a tachometer, etc. is provided on the rear side of an upper portion of the front cowl 19. A top shelter 17 as one of exterior parts of the vehicle is provided on a lower rear side of the meter panel 21. The top shelter 17 covers an area ranging from a rear portion of the front cowl 19 to a front portion of the front seat 14, and covers vehicle component parts such as the fuel tank 15, the air cleaner box 16, etc. on the upper side thereof.

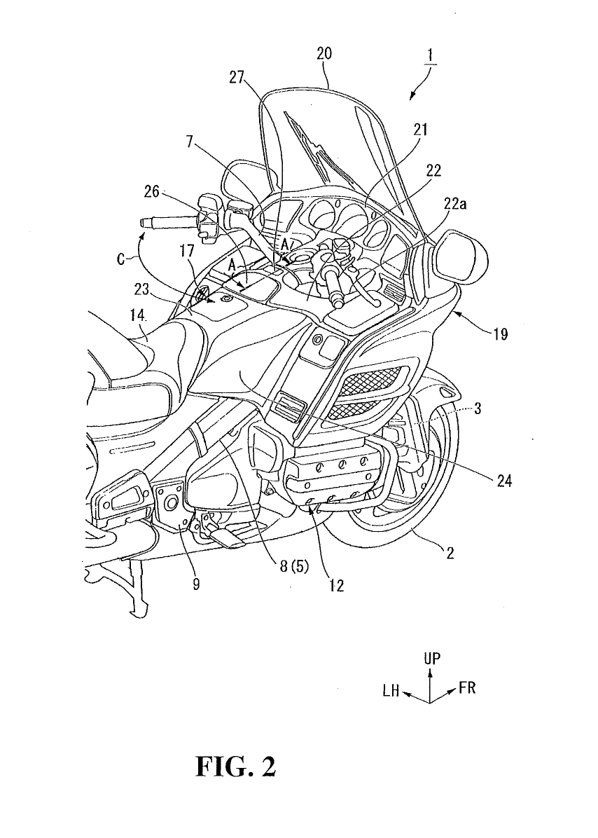

As shown in FIG. 2, the top shelter 17 is composed of a front cover 22 by which the periphery of the head pipe 6 located at a lower portion of the handlebar 7 and the steering stein 4 are covered on the upper side thereof, an upper cover 23 which is connected to a rear portion of the front cover 22 and extends to the front end of the front seat 14, and a pair of left and right side covers 24 which extend downward from side portions of the upper cover 23. The front cover 22 is provided in its upper portions with a pair of left and right slots 22a through which left and right grip parts of the handlebar 7 are led out so that they can be operated for steering.

A lid 26 is provided in substantially the central region in the vehicle width direction, on the rear side of the left and right slots 22a in the front cover 22. A pushbutton 27 for releasing a locked condition (closed condition) of the lid 26 to establish an unlocked condition is provided on the front side of the lid 26. The lid 26 is a lid member for opening and closing a storage box 25 (see FIG. 1) provided under the front cover 22. The lid 26 is so laid out that, in the closed condition, part of the lid 26 overlaps in the top plan view with a region on the inside of a locus of the turning radius C of an end portion of the handlebar 7 during steering.

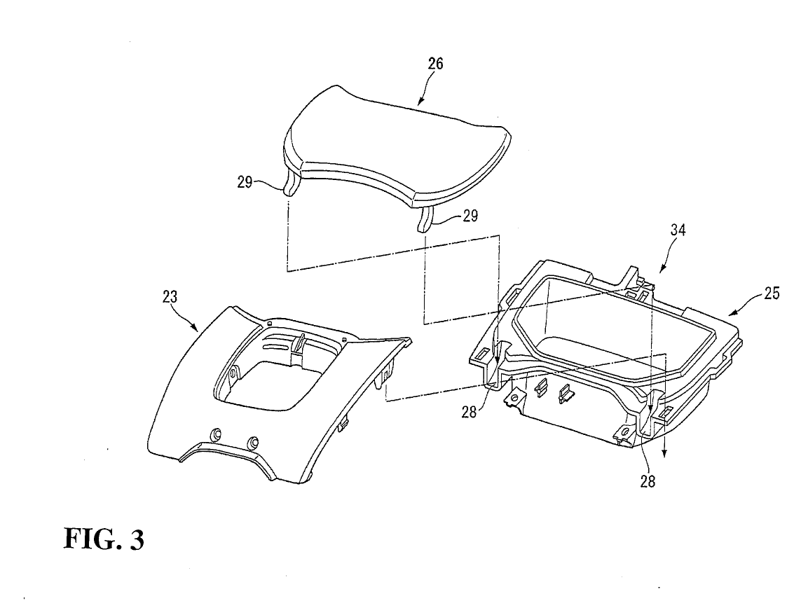

Referring to FIG. 3, the storage box 25 is formed in a box-like shape opened on the upper side, and is provided with groove parts 28, 28 at left and right side portions on the rear side thereof. Of the groove parts 28, 28, other portions than front portions are covered by the upper cover 23. The lid 26 is formed in a rectangular shape. The lid 26 is mounted to the vehicle body side by a method in which engaging pieces 29, 29 formed at left and right side portions on the rear side of the lid 26 are engaged with the groove parts 28, 28 through gaps near the upper cover 23. The lid 26 can be turned toward the rear side, with the groove parts 28, 28 as fulcrum. In addition, the lid 26 can be mounted and dismounted by disengaging the engaging pieces 29, 29 from the groove parts 28, 28.

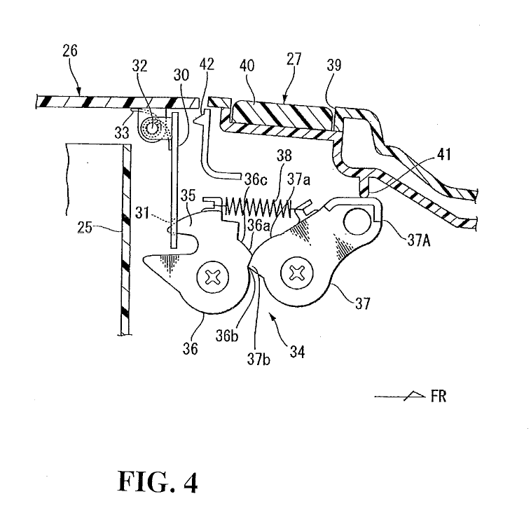

FIG. 4 shows a sectional view taken along line A-A of FIG. 2. As shown in FIG. 4, a striker 30 projecting downward is provided on the back surface of a front portion of the lid 26. The striker 30 is formed in a plate-like shape, and the striker 30 is formed with a hold hole 31 in its lower portion (tip side). The base end of the striker 30 is turnably supported on the back surface of the lid 26 through a support shaft 32, and a coil spring 33 is wound around the support shaft 32. The striker 30 is biased counterclockwise by the coil spring 33.

With the striker 30 held by a lock mechanism part 34 provided on the vehicle body side, the lid 26 is put in a closed state and in a locked condition where it is restrained from opening Referring to FIG. 3 also, the lock mechanism part 34 is provided at a front part of the storage box 25.

As shown in FIG. 4, the lock mechanism part 34 includes a first cam member 36 having a latch 35 for holding the hold hole 31 of the striker 30, and a second cam member 37 located on the front side of the first cam member 36 and engaged with the first cam member 36. The latch 35 is composed of a pair of claw bodies in a beak-like shape, and holds the hold hole 31 of the striker 30 in a clamping manner.

The lock mechanism part 34 will be described in detail. The first cam member 36 and the second cam member 37 are set in contact with each other at a front portion of the storage box 25 and are turnably supported in an aligned state, with their upper portions interconnected through a spring 38. The first cam member 36 and the second cam member 37 are provided at their peripheral portions with cam surfaces 36a and 37a where their radial size gradually increases from an upper portion toward the lower side. A groove-like notch 36b extending steeply downward from a lower-side end portion of the cam surface 36a is formed on the lower side of the cam surface 36a, and a groove-like notch 36c is formed also on the upper side of the cam surface 36a. An angular part 37b is provided at a lower-side end portion of the cam surface 37a of the second cam member 37, and the angular part 37b is engaged with the lower-side notch 36b or the upper-side notch 36c of the cam surface 36a. More specifically, the first cam member 36 and the second cam member 37 can be transferred into two kinds of postures through engaging the angular part 37b of the second cam member 37 with the notch 36b or the notch 36c of the first cam member 36 by utilizing a biasing force of the spring 38 attendant on rotation.

The second cam member 37 is formed with a depression part 37A projecting toward a front upper side. When depressed by the pushbutton 27, the depression part 37A turns the second cam member 37. The pushbutton 27 is provided on the upper side of the lock mechanism part 34, and includes a button body 40 which is contained in an opening 39 formed in the front cover 22 and which is exposed to the exterior in a depressible manner with a depression part 41 projecting downwardly from the back surface of the button body 40. When the button body 40 is depressed, the depression part 41 abuts on the depression part 37A of the second cam member 37 and turns the second cam member 37. In other words, with the depression part 41 depressed, the second cam member 37 is turned, whereby the first cam member 36 is turned, and the posture of the first cam member 36 is changed over. This results in that the latch 35 causes the hold hole 31 of the striker 30 to be immovably held or disengaged.

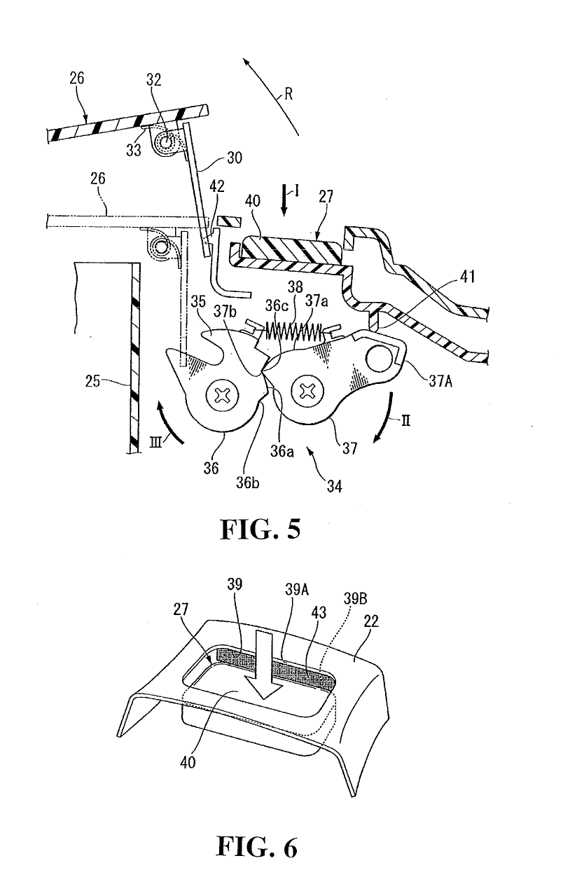

FIG. 4 shows the condition (first condition) before the button body 40 of the pushbutton 27 is depressed, and FIG. 5 shows the condition where the button body 40 of the pushbutton 27 is depressed.

The operation of the lock mechanism part 34 will be described in detail, referring to FIGS. 4 and 5. In the condition shown in FIG. 4, the angular part 37b of the second cam member 37 is in engagement with the notch 36b, and the first cam member 36 is in such a posture that its latch 35 is oriented rearwardly. In this condition, the latch 35 is immovably holding the hold hole 31 of the striker 30, and the locked condition is established in which the lid 26 is restrained from opening.

In the condition shown in FIG. 5, the pushbutton 40 has been depressed starting from the condition of FIG. 4 (arrow I). In this condition, the second cam member 37 has been turned clockwise (arrow II), the angular part 37b and the notch 36b have been disengaged from each other whereas the angular part 37b and the notch 36c have been engaged with each other, and the first cam member 36 is in such a posture that its latch 35 is oriented slightly upward (arrow III, second condition). The hold hole 31 of the striker 30 has been disengaged from the latch 35 to establish the unlocked condition where opening of the lid 26 is permitted, and the lid 26 is permitted to rise up in an opening direction (the direction of arrow R).

In addition, biasing means such as a spring may be provided so that the lid 26 pops up, or self-stands, to the upper side, whereby operability can be enhanced.

In this manner, the locking of the lid 26 by the lock mechanism part 34 is released. Here, on the vehicle body side, as shown in FIGS. 4 and 5, a hold hook 42 for immovably holding the lid 26 is provided on the upper side of the lock mechanism part 34. The hold hook 42 is provided on the vehicle body side, for example, at an appropriate position of a front portion of the storage box 25. With the hold hole 31 of the striker 30 immovably held by the hold hook 42 as shown in FIG. 5, the lid 26 having risen up in the opening direction after the unlocked condition is immovably held in a slightly opened state, that is, a half-opened state.

Thus, in this embodiment, a two-action structure is adopted in which the lid 26 is immovably held by the hold hook 42 in the half-opened state without being opened abruptly. Then, the striker 30 is in a turnable state, and when the rider turns the striker 30 by way of a gap near the slightly opened lid 26, the locked condition is released, whereby a full-opened state of the lid 26 is permitted. In addition, here, the pushbutton 27 having depressed the second cam member 37 is designed to be kept in an as-lowered state. As shown in FIG. 6, a side wall part 39B extending downward along a front-side inner edge part 39A of the opening 39 is formed on the lower side of the opening 39, and a colored tape 43 different in color from the surrounding members is adhered to the side wall part 39B. The colored tape 43 appears only after the button body 40 of the pushbutton 27 is depressed, and the appearance of the colored tape 43 functions as an alarm indication which enables the rider to recognize that the unlocked condition is established. In addition, where the front-side inner edge part 39A of the opening 39 is formed with a comparatively large material thickness, the colored tape 43 may be adhered to this part.

As above-mentioned, in this embodiment, the two-action structure is adopted wherein an operation of the pushbutton 27 releases the locked condition of the lid 26 and permits the lid 26 to rise up in the opening direction, but the lid 26 is immovably held in the half-opened state by the hold hook 42, so that the lid 26 cannot be fully opened unless the striker 30 is operated by the rider. Therefore, even when the lid 26 is opened unexpectedly, the lid 26 can be prevented from interfering with other component parts. Further, even if the lid 26 is unlocked due to a wind pressure or vibrations or even if the user has forgotten to lock the lid 26, an unexpected opening of the lid 26 can be prevented. Thus, the convenience in use is enhanced. Further, the rider can be made to be conscious of an operation of opening the lid 26.

In addition, since the lid 26 is immovably held in the half-opened state, interference between the handlebar 7 and the lid 26 can be prevented from occurring. This enables the lid 26 and the handlebar 7 to be laid out in such places that they overlap with each other in top plan view. More specifically, like in this embodiment, the lid 26 can be disposed in such a place that the lid 26 and the handlebar 7 overlap with each other. Where the lid 26 is disposed in such a place that the lid 26 and the handlebar 7 overlap with each other, the lid 26 can be disposed in such a position that the rider can use it easily. Thus, the convenience in use is enhanced. In addition, the configuration for immovably holding the lid 26 in the half-opened state is not limited to this embodiment, and a configuration may be adopted wherein the lid 26 can be disposed without being conscious of its interference with other component parts, so that the degree of freedom in layout can be enhanced.

In addition, in this embodiment, the lid 26 can be attached to and detached from the vehicle body. Therefore, the opening part at the lid 26 can be broadened, and convenience in use can be enhanced. In addition, interference of the lid 26 with other component parts can be obviated once the lid 26 is detached. Therefore, while the lid 26 is disposed in such a place that the lid 26 and the handlebar 7 overlap with each other in this embodiment, this is not limitative, and a configuration may be adopted wherein the lid 26 can be disposed without being conscious of its interference with other component parts, so that the degree of freedom in layout can be enhanced.

In addition, the colored tape 43 is provided which, when the pushbutton 27 is in the position corresponding to the unlocked condition, indicates that the unlocked condition is established. This enables the rider to recognize that the lid 26 is not locked, so that the rider can be conscious of an operation of opening the lid 26. Here, in this embodiment, the colored tape 43 as an alarm indication means is adhered to the side wall of the opening 39 for containing the pushbutton 27 so that the colored tape 43 appears only after the pushbutton 27 is depressed. Where such a configuration is adopted, the alarm indication means can be configured easily. Further, while the lid 26 is a lid of the storage box 25 in this embodiment, this ensures that the opening part is broadened and stored articles can be easily taken out of the box and put into the box.

In addition, in this embodiment, the lock mechanism part 34 corresponds to a configuration example of the lock means in the present invention, and the hold hook 42 corresponds to a configuration example of the holding means in the invention. In this embodiment, the locked condition and the half-opened state of the lid 26 can be realized by only modifying the immovably held condition of the single striker 30 provided on the lid 26, so that the number of component parts can be reduced.

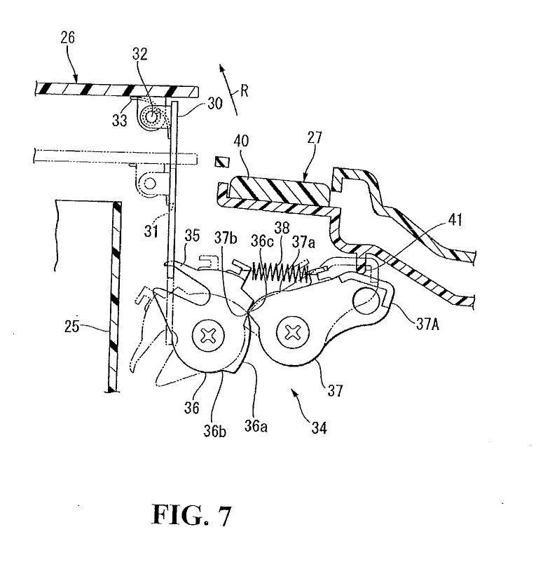

Now, a second embodiment of the present invention will be described below. FIG. 7 shows a sectional view of a lid structure according to this embodiment. The same components as those in the first embodiment above will be denoted by the same symbols as used above, and descriptions of the same components will be omitted.

In this embodiment, the hold hook 42 shown in the first embodiment above is not provided, and the locked condition of the lid 26 and the unlocked condition and the half-opened state of the lid 26 are realized by the postures of a first cam member 36 and a second cam member 37 of a lock mechanism part 34.

More specifically, FIG. 7 shows the condition where a pushbutton 27 is depressed. In this embodiment, a hold hole 31 of a striker 30 in this condition is moved upward attendant on the turning of the first cam member 36 while being immovably held by the latch 35, and the first cam member 36 pushes up the lid 26 through the striker 30, whereby the lid 26 is put into the unlocked condition and the half-opened state (second condition).

Then, with the striker 30 turned by the rider through a gap at the slightly opened lid 26, the immovably held condition of the striker 30 is released and the full-opened state of the lid 26 is permitted, this mode being the same as in the first embodiment. In addition, in the locked condition of the lid 26, as indicated by two-dotted chain lines in FIG. 7, the first cam member 36 has been turned counterclockwise from the condition shown above, and a latch 35 is oriented toward a rear lower side to immovably hold the hold hole 31 of the striker 30 (first condition).

In this embodiment, the lock mechanism part 34 corresponds to a configuration example of the lock means and the holding means in the present invention, and the lock means and the holding means are realized by the posture of the first cam member 36. In this embodiment, the immovably held condition of the striker 30 is modified by only the first cam member 36 or the like, and the locked condition and the half-opened state of the lid 26 can be thereby realized, so that influences on other component parts are little, and a reduction in cost can be achieved.

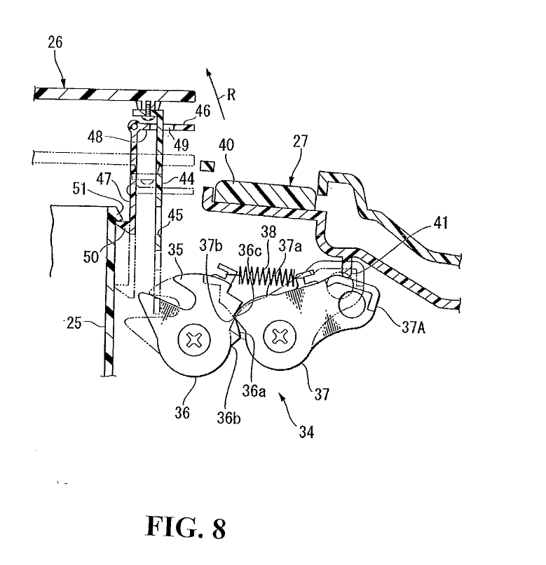

Now, a third embodiment of the present invention will be described below. FIG. 8 shows a section of a lid structure according to this embodiment. The same components as those in the first embodiment above will be denoted by the same symbols as used above, and descriptions of the same components will be omitted.

As shown in FIG. 8, in this embodiment, a plate-like striker 44 projecting downward is screwed to a back surface of a front portion of the lid 26, and the striker 44 is formed in its lower portion with a hold hole 45 similar to that in the first embodiment. Further, a lever member 48 in which end portions of a plate-shaped grip part 46 and a plate-shaped hook part 47 are connected substantially at right angles to form an L shape in section is provided on the back side of a front portion of the lid 26.

The lever member 48 is supported so as to be turnable about the connection portion between the grip part 46 and the hook part 47. The grip part 46 is formed with an opening 49, and the grip part 46 extends forward along the back surface of the lid 26, with the striker 44 passed through the opening 49. In addition, the hook part 47 extends downwardly, and is provided at its lower end with a hold part 50 bent to the rear side. The hold part 50 is engaged with and disengaged from a case-side hook 51 formed on a storage box 25 located on the rear side of the lever member 48.

In this embodiment, in the condition where the latch 35 of the first cam member 36 immovably holds the hold hole 45 of the striker 44 before the pushbutton 27 is depressed, as indicated by two-dotted chain lines in FIG. 8, a locked condition where the lid 26 is restrained from opening is established (first condition).

Then, in the condition where the pushbutton 27 is depressed as indicated by solid lines FIG. 8, the second cam member 37 is turned clockwise, the first cam member 36 is put into such a posture that its latch 35 is oriented slightly upward, whereby the hold hole 45 of the striker 44 is disengaged from the latch 35, resulting in an unlocked condition where the lid 26 is permitted to open (second condition).

Thereafter, the hold part 50 of the lever member 48 is immovably held by the case-side hook 51 of the storage box 25, and the lid 26 is put into the half-opened state.

Since the lever member 48 is supported in a turnable manner, with the lever member 48 turned in an opening direction for the lid 26 (the direction of arrow R) by the rider through a gap at the slightly opened lid 26, the immovable holding between the hold part 50 and the case-side hook 51 is released, whereby a frill-opened state of the lid 26 is permitted. In this embodiment, since an operation of opening the lid 26 can be performed by use of the lever member 48, the convenience in use for the rider can be enhanced.

In addition, the configurations in the above embodiments are mere examples of the present invention, and various modifications inclusive of modifications in the configurations, structures, shapes, sizes, numbers, layout, etc. of component parts are possible without a departure from the scope of the invention. For instance, while the invention has been applied to a motorcycle in the above embodiments, the invention can be suitably applied also to other vehicles such as a three-wheel vehicle provided with left and right wheels on the front side and a single wheel on the rear side.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lid structure for a vehicle, comprising:
a lid provided on a vehicle body and capable of being opened and closed;
lock means for maintaining a closed state of the lid to establish a locked condition; and
operating means for releasing the locking of the lock means to establish an unlocked condition, with the lid caused to rise up in an opening direction or with the lid permitted to rise up in the opening direction, according to an operation of the operating means for unlocking;
wherein holding means is provided for immovably holding in a half-opened state the lid put into the unlocked condition by the operating means, and a full-opened state of the lid is permitted when the holding of the holding means is released by an operator.

2. The lid structure for the vehicle according to claim 1, wherein the lid is capable of being attached to and detached from the vehicle body.

3. The lid structure for the vehicle according to claim 1, wherein alarm indication means is provided which, when the operating means is in a position corresponding to the unlocked condition, indicates an alarm meaning that the unlocked condition is established.

4. The lid structure for the vehicle according to claim 2, wherein alarm indication means is provided which, when the operating means is in a position corresponding to the unlocked condition, indicates an alarm meaning that the unlocked condition is established.

5. The lid structure for the vehicle according to claim 1, wherein the vehicle has a steering mechanism and a handle for operating the steering mechanism; and
the lid is disposed on a vehicle body upper surface at such a position that at least part of the lid overlaps, in top plan view, with a region on the inside of a locus of turning of an end portion of the handle during steering.

6. The lid structure for the vehicle according to claim 2, wherein the vehicle has a steering mechanism and a handle for operating the steering mechanism; and
the lid is disposed on a vehicle body upper surface at such a position that at least part of the lid overlaps, in top plan view, with a region on the inside of a locus of turning of an end portion of the handle during steering.

7. The lid structure for the vehicle according to claim 3, wherein the vehicle has a steering mechanism and a handle for operating the steering mechanism; and
the lid is disposed on a vehicle body upper surface at such a position that at least part of the lid overlaps, in top plan view, with a region on the inside of a locus of turning of an end portion of the handle during steering.

8. The lid structure for the vehicle according to claim 1, wherein the vehicle has a storage box and the lid is a lid of the storage box.

9. The lid structure for the vehicle according to claim 2, wherein the vehicle has a storage box and the lid is a lid of the storage box.

10. The lid structure for the vehicle according to claim 3, wherein the vehicle has a storage box and the lid is a lid of the storage box.

11. The lid structure for the vehicle according to claim 5, wherein the vehicle has a storage box and the lid is a lid of the storage box.

12. The lid structure for the vehicle according to claim 1, wherein the holding means is a latch wherein a striker provided on the lid is immovably held in an engageable and disengageable manner.

13. The lid structure for the vehicle according to claim 12, wherein a turnable cam member having the latch constituting the holding means is provided on the lower side of the operating means;
the cam member can be transferred to a first state in which the operating means is not yet operated and a second state which is reached through turning from the first state when the operating means is operated to abut against the cam member; and
it is ensured that in the first state, the striker is immovably held by the latch to establish the locked condition, that in the second state, the striker is moved while being immovably held by the latch to establish the half-opened state together with the unlocked condition, and that the full-opened state of the lid is permitted when the striker immovably held by the latch is disengaged by the rider after the second state.

14. The lid structure for the vehicle according to claim 1, wherein the lock means is composed of a latch by which a striker provided on the lid is immovably held in an engageable and disengageable manner, and the holding means is composed of a hook member which is provided on the vehicle body separately from the latch and by which the striker is immovably held in an engageable and disengageable manner.

15. The lid structure for the vehicle according to claim 14, wherein a turnable cam member having the latch constituting the lock means is provided on the lower side of the operating means;
the cam member can be transferred to a first state in which the operating means is not yet operated and a second state which is reached through turning from the first state when the operating means is operated to abut on the cam member; and
it is ensured that in the first state, the striker is immovably held by the latch to establish the locked condition, that in the second state, the striker is released from the held-by-latch state to establish the unlocked condition, and that the fully-opened state of the lid is permitted when, after the second state, the striker is immovably held by the hook member to establish a half-opened state and the striker immovably held by the hook member is disengaged by the rider.

16. The lid structure for the vehicle according to claim 15, wherein a lever member for releasing the immovable holding between the striker and the hook member is provided, and the immovable holding between the striker and the hook member is released when the lever member is operated in an opening direction for the lid.

17. The lid structure for the vehicle according to claim 3, wherein the operating means is a pushbutton contained in an opening provided in a vehicle body upper surface, the alarm indication means is provided at an inner edge portion of the opening or at a side wall portion extending downward along the inner edge portion of the opening, and the alarm indication means appears only in the condition where the pushbutton is depressed.

18. A lid structure for a vehicle, comprising:
a lid adapted to be mounted on a vehicle body having a storage box formed therein, said lid being capable of being opened and closed for sealing a top opening of the storage box;
a lock for securing the lid in a closed state relative to the top opening of the storage box to establish a locked condition;
a release member for selectively releasing the lock to establish an unlocked condition wherein the lid is enabled to be moved in an opening direction, according to an operation of the release member for unlocking the lid relative to the top opening of the storage box; and
a holder member operatively connected to the lid for immovably holding the lid initially in a half-opened state when said holder member is in a first position, said holder member being movable to a second position wherein said lid is in a full-opened state.

19. The lid structure for the vehicle according to claim 18, wherein an alarm is provided which, when the release member is in a position corresponding to the unlocked condition, indicates an alarm meaning that the unlocked condition is established.

20. The lid structure for the vehicle according to claim 18, wherein the holder member is a latch wherein a striker provided on the lid is immovably held in an engageable and disengageable manner.
